(19) United States
(12) Patent Application Publication
(10) Pub. No.: US 2024/0111558 A1
(43) Pub. Date: Apr. 4, 2024

(54) AUTO-SCALING HOST MACHINES

(71) Applicant: Citrix Systems, Inc., Fort Lauderdale, FL (US)

(72) Inventor: Leo C. Singleton, IV, Fort Lauderdale, FL (US)

(21) Appl. No.: 17/936,397

(22) Filed: Sep. 29, 2022

(51) Int. Cl. G06F 9/455; G06F 9/50

(52) U.S. Cl. CPC G06F 9/45558; G06F 9/5077; G06F 2009/45562; G06F 2009/45575; G06F 2209/5019

(57) ABSTRACT

According to one aspect, a method can include: receiving, by a computing device, historical data for an organization having a plurality of host machines that can be selectively powered on to provide capacity for hosting computing sessions; receiving, by a computing device, a configuration value of the organization indicating a probability that there will be available capacity when new computing sessions are initiated; determining, by the computing device, capacities needed to satisfy the probability at different points in time based on the historical data; and auto-scaling the host machines at one or more times according to the determined capacities.

### BACKGROUND

Virtual desktop infrastructure (VDI) and desktop as a service (DaaS) systems enable users to access virtual applications and desktops hosted on remote machines using various types of client devices. The host machines can include physical desktop computers and servers within an on-premises (or “on-prem”) infrastructure and/or or virtual machines (VMs) running on top of an on-prem hypervisor or within a cloud-based system. VDI/DaaS systems are used by many different types of organizations, such as businesses, schools, government agencies, etc. and, as such. A VDI/DaaS system may provide virtual application/desktop access to one or more organizations, each of which can have many end users. In the case of DaaS, virtual application/desktop resources for many different organizations (or “customers”) may be hosted within a common cloud-based computing environment.

Some VDI/DaaS systems—such as CITRIX DAAS and AZURE VIRTUAL DESKTOPS—provide auto-scaling functionality to dynamically adjust the capacity of the system by powering host machines on and off. For example, during periods of increased load, the system may power on additional host machines to increase capacity. At other times, the system may power off host machines to reduce costs, e.g. cloud hosting costs and/or energy costs. Auto-scale may be configurable by organization administrators, and such configuration can vary from one organization to another. Existing systems generally provide two types of auto-scale policies: (1) schedule-based policy, such as rules that specify minimum capacity based on time-of-day, and (2) load-based policy, such rules that specify when capacity should be increased/decreased based on CPU utilization, available memory, or other measures of load. These existing policies can be used in combination, with schedule-based policy providing a minimum capacity and load-based policy providing additional “buffer” capacity. Existing auto-scale policies expose various different settings that can be manually adjusted by administrators.

### SUMMARY

With auto-scaling, there is generally a tradeoff between user experience and costs. On the one hand, it is desirable to maintain a sufficient capacity to accommodate end user demand (e.g., demand for virtual applications/desktops) at all times. If there is insufficient capacity, a user may have to wait for an additional host machine to be powered on before they can logon and begin their virtual applications/desktop session. As used herein, “power on” refers to powering on a physical machine or loading a VM by a hypervisor, as well performing all prerequisite operations to render the machine becomes accessible to end users, such as executing the boot sequence, initializing the operating system (OS) and desktop environment, initializing system services, etc. The time it takes to power on a host machine, referred to herein as “power-on time,” can be between several seconds and several minutes. For example, if the hypervisor provides a VM hibernation capability, a host machine may power on in a matter of seconds (e.g., between 5 and 15 seconds). Otherwise, it may take several minutes to power on a host machine (e.g., between 2 and 5 minutes). In any case, making a user wait for a host machine to power on is generally a poor user experience and can reduce productivity. On the other hand, having excess capacity results in wasted costs. Some organizations may prefer to have excess capacity in order to provide a better user experience at greater cost, while other organizations may prefer to reduce costs at the expense of user experience.

It is appreciated herein, with existing systems, it may be difficult for an administrator to configure auto-scaling to achieve their organization's preferred balance of user experience versus cost. In particular, it can be difficult if not impossible to achieve the preferred balance using existing schedule-based and load-based auto-scale policies, leading to a worse user experience and/or higher costs than desired.

Described herein are systems, techniques, and structures that enable organizations to easily configure auto-scaling to achieve their preferred (or “optimal”) balance of user experience versus cost. Disclosed embodiments provide a new type of auto-scale policy, referred to herein as a “balanced policy,” that exposes a single configuration value, P, corresponding to the probability that there will be available capacity to immediately serve any given user when the user logs on (i.e., without waiting for a host machine to power on). Disclosed embodiments automatically generate one or more statistical models for an organization using historical data tracked for the organization and the probability P set for the organization, and use the model(s) to auto-scale host machines at different times of the day, days of the week, etc. Disclosed embodiments provide an administrative user interface (UI) for adjusting the probability P using a single UI control, such as a slider, dial/knob, text input, etc.

Disclosed embodiments can be integrated into existing VDI/DaaS systems, thereby improving the efficiency and utility of such computing systems, for example by reducing resource usage and costs and/or by improving the user experience.

According to one aspect of the disclosure, a method can include: receiving, by a computing device, historical data for an organization having a plurality of host machines that can be selectively powered on to provide capacity for hosting computing sessions; receiving, by a computing device, a configuration value of the organization indicating a probability that there will be available capacity when new computing sessions are initiated; determining, by the computing device, capacities needed to satisfy the probability at different points in time based on the historical data; and auto-scaling the host machines at one or more times according to the determined capacities.

In some embodiments, the receiving of the historical data may include: receiving data about numbers of logons that occurred at the different points in time; and receiving data about amounts of time required to power on one or more of the host machines at the different points in time. In some embodiments, the different points in time can include times of day. In some embodiments, the receiving of the historical data may include receiving historical data associated with multiple 24-hour periods. In some embodiments, the auto-scaling of the host machines at the one or more times can include: determining a current time-of-day; determining, from the at determined capacities, a target capacity needed to satisfy the probability at the current time-of-day; and powering on at least one of the plurality of host machines to achieve the target capacity. In some embodiments, the computing sessions may include virtual desktop sessions. In some embodiments, the auto-scaling of the host machines at the one or more times can include: periodically auto-scaling the host machines at one or more times according to the determined capacities. In some embodiments, the determining of the capacities needed to satisfy the probability at the different points in time can include: determining a current day-of-week, selecting, from the historical data, data associated with the current day-of-week, and determining the capacities needed to satisfy the probability at the different points in time based on the selected data.

According to another aspect of the disclosure, an apparatus can include a processor and a memory storing computer program code that when executed on the processor causes the processor to execute any of the above method embodiments.

According to another aspect of the disclosure, a non-transitory machine-readable medium can encode instructions that when executed by one or more processors cause any of the above method embodiments to be carried out.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 depicts an illustrative computer system architecture that may be used in accordance with one or more illustrative aspects of the concepts described herein.

FIG. 2 depicts an illustrative remote-access system architecture that may be used in accordance with one or more illustrative aspects of the concepts described herein.

FIG. 3 depicts an illustrative virtualized (hypervisor) system architecture that may be used in accordance with one or more illustrative aspects of the concepts described herein.

FIG. 4 depicts an illustrative cloud-based system architecture that may be used in accordance with one or more illustrative aspects of the concepts described herein.

FIG. 5 is a network diagram of an illustrative computer system that provides auto-scale using statistical models, according to some embodiments.

FIG. 6 is a plot showing an example of user count at different times of a day.

FIG. 7 is a plot showing an example of auto-scaling that may occur using existing schedule-based and load-based policies.

FIG. 8 is a series of plots illustrating historical data that can be tracked and used to generate a statistical model for auto-scaling, according to some embodiments.

FIG. 9 is a plot showing an example of improved auto-scaling that can be achieved using a statistical model, according to some embodiments.

FIG. 10 is diagram of an illustrative user interface (UI) for configuring auto-scaling, according to some embodiments.

FIG. 11 is flow diagram showing an illustrative method for auto-scaling using statistical models, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

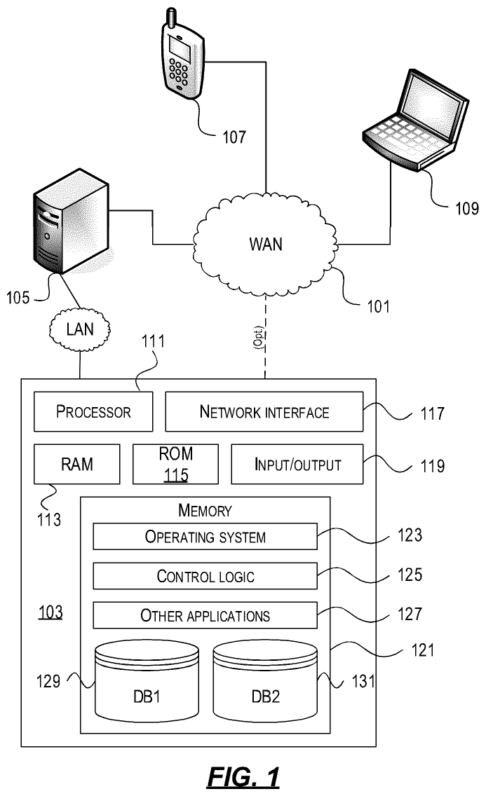

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects of the concepts described herein in a standalone and/or networked environment. Various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity—which resides across all physical networks.

The components and devices which make up the system of FIG. 1 may include data server 103, web server 105, and client computers 107, 109. Data server 103 provides overall access, control and administration of databases and control software for performing one or more illustrative aspects of the concepts described herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects of the concepts described herein, and other application software 127 providing secondary, support, and/or other functionality which may or might not be used in conjunction with aspects of the concepts described herein. The control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects of the concepts described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the concepts described herein, and such data structures are contemplated within the scope of computer executable instructions and computer-usable data described herein.

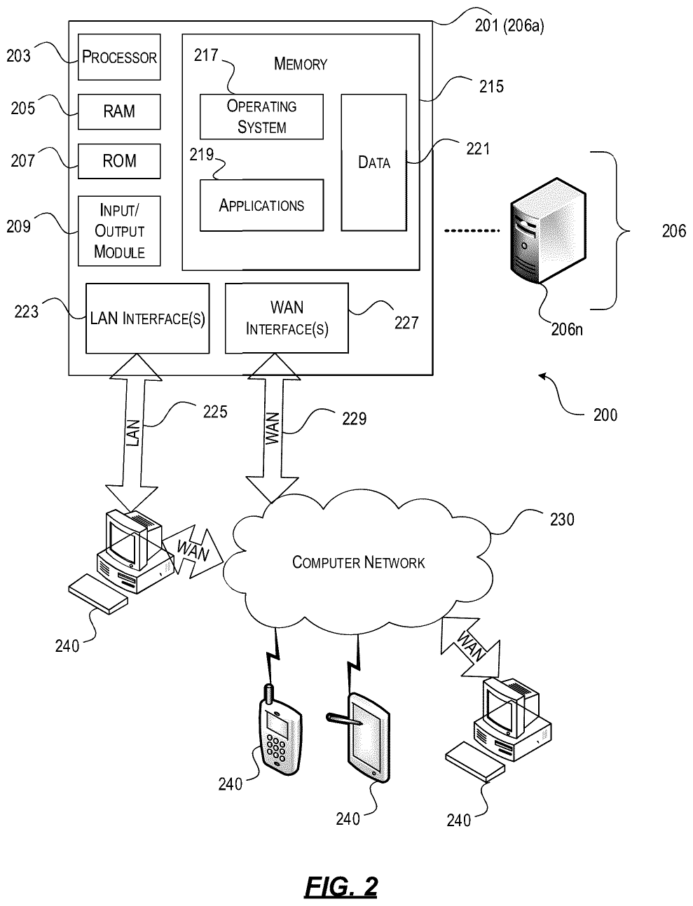

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects of the concepts described herein. Computing device 201 may be used as a server 206a in a single-server or multi-server desktop virtualization system (e.g., a remote access or cloud system) configured to provide VMs for client access devices. The computing device 201 may have a processor 203 for controlling overall operation of the server and its associated components, including RAM 205, ROM 207, input/output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all the elements described above with respect to the data server 103 or computing device 201. The network connections depicted in FIG. 2 include a local area network (LAN) 225 and a wide area network (WAN) 229 but may also include other networks. When used in a LAN networking environment, computing device 201 may be connected to the LAN 225 through an adapter or network interface 223. When used in a WAN networking environment, computing device 201 may include a modem or other wide area network interface 227 for establishing communications over the WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects of the concepts described herein may also be operational with numerous other general purpose or special purpose computing system environments or configurations. Examples of other computing systems, environments, and/or configurations that may be suitable for use with aspects of the concepts described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, the computing environment 200 may include a network appliance installed between the server(s) 206 and terminals 240. The network appliance may manage client/server connections, and in some cases can load balance client connections amongst a plurality of back-end servers 206.

The terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

A terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). The server 206, in some embodiments, may be referred to as any one of the following non-exhaustive terms: server(s), local machine; remote machine; server farm(s), or host computing device(s).

In one embodiment, the terminal 240 may be a VM. The VM may be any VM, while in some embodiments the VM may be any VM managed by a Type 1 or Type 2 hypervisor, for example, a hypervisor developed by Citrix Systems, IBM, VMware, or any other hypervisor. In some aspects, the VM may be managed by a hypervisor, while in other aspects the VM may be managed by a hypervisor executing on a server 206 or a hypervisor executing on a terminal 240.

Some embodiments include a terminal 240 that displays application output generated by an application remotely executing on a server 206 or other remotely located machine. In these embodiments, the terminal 240 may execute a VM receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Fort Lauderdale, Florida; or the Remote Desktop Protocol (RDP) manufactured by Microsoft Corporation of Redmond, Washington.

A remote computing environment may include more than one server 206a-206n logically grouped together into a server farm 206, for example, in a cloud computing environment. The server farm 206 may include servers 206a-206n that are geographically dispersed while logically grouped together, or servers 206a-206n that are located proximate to each other while logically grouped together. Geographically dispersed servers 206a-206n within a server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, the server farm 206 may be administered as a single entity, while in other embodiments the server farm 206 can include multiple server farms.

In some embodiments, a server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from a terminal 240, forwards the request to a second server 206b (not shown), and responds to the request generated by the terminal 240 with a response from the second server 206b (not shown). First server 206a may acquire an enumeration of applications available to the terminal 240 as well as address information associated with an application server 206 hosting an application identified within the enumeration of applications. First server 206a can present a response to the client's request using a web interface and communicate directly with the terminal 240 to provide the terminal 240 with access to an identified application. One or more terminals 240 and/or one or more servers 206 may transmit data over network 230, e.g., network 101.

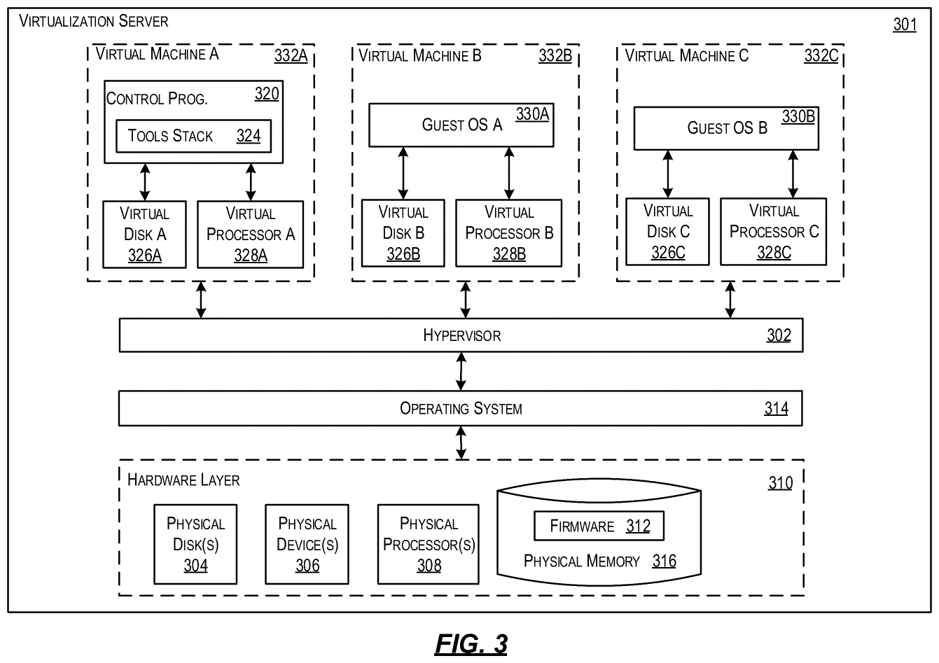

FIG. 3 shows a high-level architecture of an illustrative application virtualization system. As shown, the application virtualization system may be single-server or multi-server system, or cloud system, including at least one virtualization server 301 configured to provide virtual desktops and/or virtual applications to one or more terminals 240 (FIG. 2). As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an operating system running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer 310 that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more VMs 332A-C (generally 332). Each VM 332 may have a virtual disk 326A-C and a virtual processor 328A-C. In some embodiments, a first VM 332A may execute, using a virtual processor 328A, a control program 320 that includes a tools stack 324. Control program 320 may be referred to as a control VM, Dom0, Domain 0, or other VM used for system administration and/or control. In some embodiments, one or more VMs 332B-C can execute, using a virtual processor 328B-C, a guest operating system 330A-B.

Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

In some embodiments, hypervisor 302 may be a program executed by processors 308 on virtualization server 301 to create and manage any number of VMs 332. Hypervisor 302 may be referred to as a VM monitor, or platform virtualization software. In some embodiments, hypervisor 302 can be any combination of executable instructions and hardware that monitors VMs executing on a computing machine. Hypervisor 302 may be Type 2 hypervisor, where the hypervisor executes within an operating system 314 executing on the virtualization server 301. VMs may execute at a level above the hypervisor. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301 and may include program data stored in the physical memory 316.

Hypervisor 302, in some embodiments, can provide virtual resources to operating systems 330 or control programs 320 executing on VMs 332 in any manner that simulates the operating systems 330 or control programs 320 having direct access to system resources. System resources can include, but are not limited to, physical devices 306, physical disks 304, physical processors 308, physical memory 316, and any other component included in virtualization server 301 hardware layer 310. Hypervisor 302 may be used to emulate virtual hardware, partition physical hardware, virtualize physical hardware, and/or execute VMs that provide access to computing environments. In still other embodiments, hypervisor 302 may control processor scheduling and memory partitioning for a VM 332 executing on virtualization server 301. In some embodiments, virtualization server 301 may execute a hypervisor 302 that creates a VM platform on which guest operating systems may execute. In these embodiments, the virtualization server 301 may be referred to as a host server. An example of such a virtualization server is the Citrix Hypervisor provided by Citrix Systems, Inc., of Fort Lauderdale, Florida.

Hypervisor 302 may create one or more VMs 332B-C (generally 332) in which guest operating systems 330 execute. In some embodiments, hypervisor 302 may load a VM image to create a VM 332. In other embodiments, the hypervisor 302 may execute a guest operating system 330 within VM 332. In still other embodiments, VM 332 may execute guest operating system 330.

In addition to creating VMs 332, hypervisor 302 may control the execution of at least one VM 332. In other embodiments, hypervisor 302 may present at least one VM 332 with an abstraction of at least one hardware resource provided by the virtualization server 301 (e.g., any hardware resource available within the hardware layer 310). In other embodiments, hypervisor 302 may control the way VMs 332 access physical processors 308 available in virtualization server 301. Controlling access to physical processors 308 may include determining whether a VM 332 should have access to a processor 308, and how physical processor capabilities are presented to the VM 332.

As shown in FIG. 3, virtualization server 301 may host or execute one or more VMs 332. A VM 332 is a set of executable instructions that, when executed by a processor 308, may imitate the operation of a physical computer such that the VM 332 can execute programs and processes much like a physical computing device. While FIG. 3 illustrates an embodiment where a virtualization server 301 hosts three VMs 332, in other embodiments virtualization server 301 can host any number of VMs 332. Hypervisor 302, in some embodiments, may provide each VM 332 with a unique virtual view of the physical hardware, memory, processor, and other system resources available to that VM 332. In some embodiments, the unique virtual view can be based on one or more of VM permissions, application of a policy engine to one or more VM identifiers, a user accessing a VM, the applications executing on a VM, networks accessed by a VM, or any other desired criteria. For instance, hypervisor 302 may create one or more unsecure VMs 332 and one or more secure VMs 332. Unsecure VMs 332 may be prevented from accessing resources, hardware, memory locations, and programs that secure VMs 332 may be permitted to access. In other embodiments, hypervisor 302 may provide each VM 332 with a substantially similar virtual view of the physical hardware, memory, processor, and other system resources available to the VMs 332.

Each VM 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each VM 332 with a unique view of the physical disks 304. Thus, in these embodiments, the particular virtual disk 326 included in each VM 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all the same characteristics of at least one physical processor 308. In other embodiments, virtual processor 328 provides a modified view of physical processors 308 such that at least some of the characteristics of the virtual processor 328 are different than the characteristics of the corresponding physical processor 308.

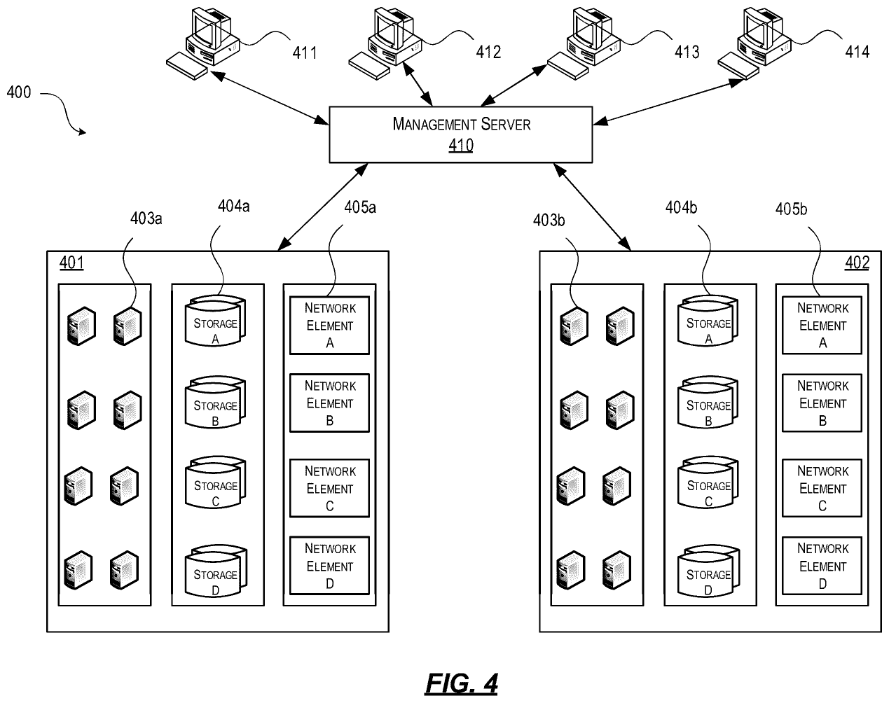

With further reference to FIG. 4, some aspects of the concepts described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred to herein as “host servers 403”), storage resources 404a-404b (generally referred to herein as “storage resources 404”), and network resources 405a-405b (generally referred to herein as “network resources 405”)) of the cloud system.

Management server 410 may be implemented on one or more physical servers. The management server 410 may include, for example, a cloud computing platform or solution, such as APACHE CLOUDSTACK by Apache Software Foundation of Wakefield, MA, among others. Management server 410 may manage various computing resources, including cloud hardware and software resources, for example, host servers 403, storage resources 404, and network resources 405. The cloud hardware and software resources may include private and/or public components. For example, a cloud environment may be configured as a private cloud environment to be used by one or more customers or client computers 411-414 and/or over a private network. In other embodiments, public cloud environments or hybrid public-private cloud environments may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy VMs within the cloud environment. Client computers 411-414 may connect to management server 410 via the Internet or some other communication network and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage VMs and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain client computers 411-414 may be related, for example, different client computers creating VMs on behalf of the same end user, or different users affiliated with the same company or organization. In other examples, certain client computers 411-414 may be unrelated, such as users affiliated with different companies or organizations. For unrelated clients, information on the VMs or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud computing resources. For example, zone 401 may be a first cloud datacenter located in California and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud environment (e.g., client computers 411-414) might or might not be aware of the distinctions between zones. For example, an end user may request the creation of a VM having a specified amount of memory, processing power, and network capabilities. The management server 410 may respond to the user's request and may allocate resources to create the VM without the user knowing whether the VM was created using resources from zone 401 or zone 402. In other examples, the cloud system may allow end users to request that VMs (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more host servers 403, such as the virtualization servers 301 (FIG. 3), which may be configured to create and host VM instances. The physical network resources in a cloud zone 401 or 402 may include one or more network resources 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment 400 shown in FIG. 4 also may include a virtualization layer (e.g., as shown in FIGS. 1-3) with additional hardware and/or software resources configured to create and manage VMs and provide other services to customers using the physical resources in the cloud environment. The virtualization layer may include hypervisors, as described above in connection with FIG. 3, along with other components to provide network virtualizations, storage virtualizations, etc. The virtualization layer may be as a separate layer from the physical resource layer or may share some or all the same hardware and/or software resources with the physical resource layer. For example, the virtualization layer may include a hypervisor installed in each of the host servers 403 with the physical computing resources. Known cloud systems may alternatively be used, e.g., WINDOWS AZURE (Microsoft Corporation of Redmond, Washington), AMAZON EC2 (Amazon.com Inc. of Seattle, Washington), IBM BLUE CLOUD (IBM Corporation of Armonk, New York), or others.

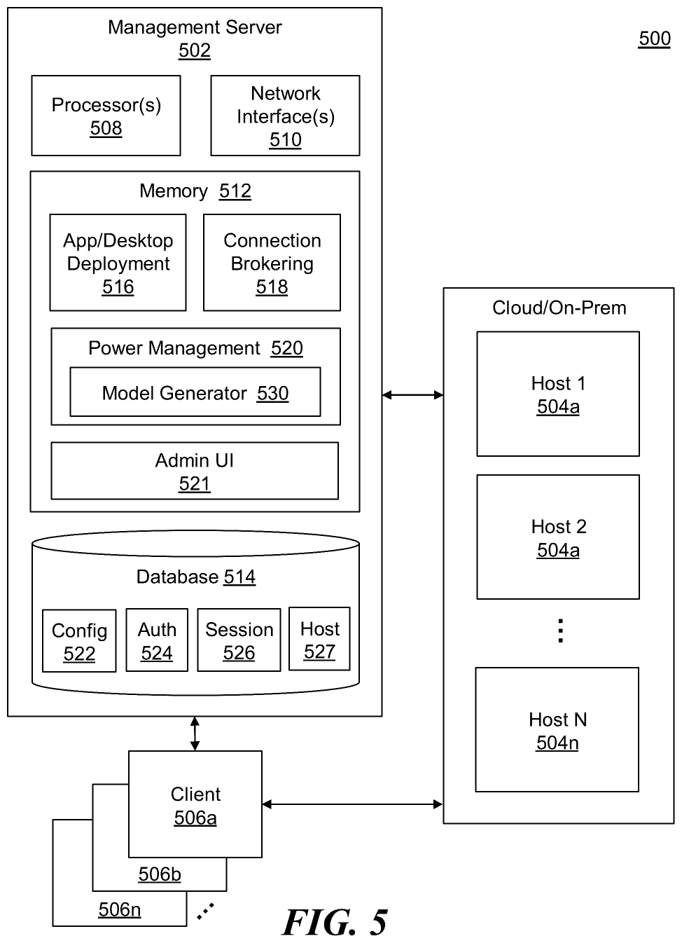

Turning to FIG. 5, a computer system 500 can provide auto-scale using statistical models, according to some embodiments. The illustrative system 500 includes a management server 502, one or more host machines 504a, 504b, . . . , 504n (504 generally), and or more clients 506a, 506b, . . . , 506n (506 generally). In some embodiments, management server 502 and host machines 504 may comprise, be part of, a VDI or DaaS environment.

Clients 506 can communicate with management server 502 and host machines 504 via one or more computer networks (not shown) and management server 502 can communicate with hosts 504 via the same or default computer network(s). The computer network(s) can may comprise any type and form of network, including a local area network (LAN), medium or metropolitan area network (MAN), wide area network (WAN) such as the Internet, or a combination of these or other networks. In some embodiments, management server 502 and/or host machines 504 may be behind a firewall, relative to clients 506, and clients 506 may communicate with management server 502 and/or host machines via a gateway device (not shown).

Host machines 504 can be configured to run virtual applications and desktops deployed by the management server 502 and accessed by clients 506 (i.e., by end users using clients 506). In some embodiments, host machines 504 may correspond to physical desktop computers and/or servers within an on-premises (or “on-prem”) infrastructure. In some embodiments, host machines 504 may correspond to VMs that run on top of a hypervisor that is hosted on-prem, or that run within a cloud-based system. Host machines 504 can include hardware and/or software to interoperate with management server 502 to provide clients 506 with access to virtual applications/desktops. For example, individual ones of host machines 504 can include an agent-sometimes referred to as a virtual delivery agent (VDA)-configured to register the host machine with the management server 502, manage connections between the host machine and one or more clients 506, communicate session information to management server 502 (e.g., information identifying which applications are running within a session), communicate system-level metrics of the host machine (e.g., processor usage, memory usage, disk usage, etc.) to management server 502, and/or perform various other VDI/DaaS-related functions. In some embodiments, a VDA running on a host machine 504 can notify management server 502 when the host machine has completed powering up, meaning when it becomes accessible to end users after completing its boot sequence, initializing the OS and system services, etc.

Management server 502—sometimes referred to as a delivery controller—may correspond to one or more physical servers and/or virtual machine-based servers configured to run various services for providing clients 506 with access to virtual applications and desktops running on host machines 504.

System 500 may be configured for us by a single organization or by multiple organizations, where a given organization can have many end users. In some embodiments, a single instance of management server 502 may operate to provide virtual application/desktop access to multiple different organizations. In some embodiments, different instances of management server 502 may be operated for different organizations. In some embodiments, host machines 504 for multiple different organizations may be deployed within the same cloud-based system (e.g., within different tenants of the same cloud-based system). In some embodiments, a single instance of management server 502 may deploy, and provide access to, virtual applications/desktops within multiple different cloud-based systems and/or on-prem infrastructures.

Management server 502 may include one or more processors 508, such as single core processors, multi-core processors, virtual processors provided as part of a virtual machine executed by one or more physical machines, graphics processing units (GPUs), or combination thereof. Management server 502 may further include one or more network interfaces 510 for communicating with host machines 504 and clients 506 via the computer network(s). Network interfaces 510 can include, for example, an Ethernet interface, WiFi interface, cable broadband interface, Bluetooth interface, or combination thereof. In some implementations, network interfaces 510 may provide a portion or all of a network stack, and may include packet processing units, flow controllers, or other such elements. Network interfaces 510 may include hardware, software, or a combination of hardware and software for processing packets and communicating with host machines 504 and clients 506.

Management server 502 may further include one or more memory devices 512 for storing instructions and data for one or more computer applications, programs, components, packages, libraries, services, etc. executable by processor 508. A memory device 512 can include, for example, RAM, ROM, a hard drive, or other type of memory device. In the example shown, memory devices 512 can store data and instructions for an application/desktop deployment service 516, a connection brokering service 518, a power management service 520, and an administrative UI 521. Memory devices 512 can also store data and instructions for an operating system (not illustrated) upon which services 516, 518, 520 can execute. The services 516, 518, 520 shown in FIG. 5 are merely illustrative and are not intended to be inclusive of all services that may be provided by a VDI/DaaS management server.

Deployment service 516 can be configured to distribute (or “deliver”) applications and desktops to host machines 504. For example, deployment service 516 can configure host machines 504 to use particular images (e.g., virtual machine images) that include a desktop environment (e.g., WINDOWS) and one or more pre-installed applications. As another example, deployment service 516 can cause applications to be streamed across the network to host machines 504, meaning the applications are profiled and delivered to host machines 504 on demand. Various other techniques can be used to distribute desktops and applications to host machines 504.

Connection brokering service 518 can broker connections between end users and their virtual desktops and applications. Brokering service 518 can track various information about virtual application/sessions. For example, for a given session, brokering service 518 can track the date/time of when the session was created (e.g., the date/time the end user logged on to the session), information identifying the user for whom the session was created, information identifying the host machine 504 on which the session is currently running on or is otherwise associated with, information identifying one or more applications running within or otherwise associated with the session, the state of the session (e.g., connected versus disconnected), among various other session-related information. Brokering service 518 can receive requests from clients 506 to access particular virtual application/desktop resources, authenticate end users associated with those requests, assign virtual application/desktop resources on particular host machines 504 to the end users, and provide clients 506 with information necessary to connect (and subsequently reconnect) to their assigned virtual application/desktop resources. When processing a request to access a virtual application/desktop resource, brokering service 518 can determine if the user has an existing session associated with that resource and provide the requesting client 506 with information to reconnect to their existing virtual application/desktop session, rather than creating a new session.

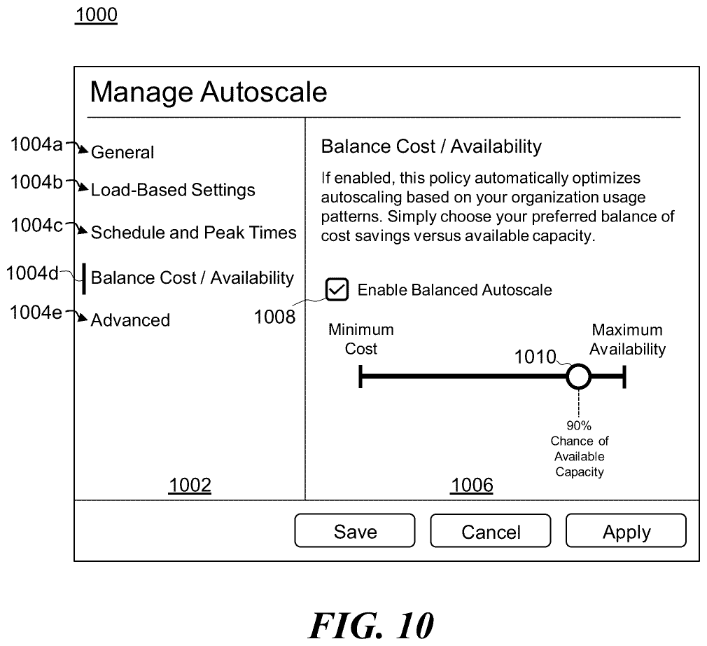

Power management service 520 can manage the state of host machines 504, powering them on and off—or otherwise starting and stopping them—according to auto-scale policies defined by individual organizations. In some embodiments, the auto-scale policies can be defined by administrative users associated with the organizations using the administrative UI 521, an example of which is discussed below in conjunction with FIG. 10. Power management service 520 may implement conventional auto-scale policies, such as schedule- and load-based policies, along with a so-called “balanced” auto-scale policy disclosed herein.

In general, auto-scale is a tradeoff between user experience and cost. At one extreme, an organization may choose to leave all of their host machines powered on at all times. This can result in the best user experience (no user ever waits at logon) but may incur the highest costs. At the other extreme, an organization can minimize costs by never powering on any host machines in advance of a user's logon, and immediately powering off a host machine after all users log off (e.g., when the number of sessions on the host machine drops to zero). In this case, most if not all logons may result in a user waiting for a host machine to power on, providing a poor user experience. Most organizations want some balance between these two extremes. As mentioned previously, it may be difficult if not impossible for an administrator to achieve their preferred/optimal balance of user experience versus cost using conventional auto-scale policies.

To address this problem, power management service 520 may provide a balanced auto-scale policy, in addition to or in place of conventional auto-scale policies. According to a balanced policy, an organization's preferred balance of user experience versus cost can be expressed as a single configuration value P, defined as the probability that there will be available capacity when new computing sessions are initiated. For a given organization, P can be set in the range of 0% to 100% or, equivalent, in the range 0.0 to 1.0. An organization that favors cost savings may, for example, set P=90% such that, on average, one out of every ten logons must wait for a host machine to power on. Another organization that favors user experience might choose a higher value for P, e.g. P=99.9%, such that, on average, one out of every thousand logons must wait for a host machine to power on.

As used herein, the term “capacity” can refer to a number of concurrent sessions, including both connected and disconnected sessions (disconnected sessions can still consume CPU, memory, etc.). Equivalently or alternatively, “capacity” can refer to a number active users, meaning the number of users that are concurrently logged on. The term “actual capacity” refers to the total capacity provided by the set of host machines 504 that are powered-on at a given time for an organization. Actual capacity can be calculated as the sum of the capacities of the individual powered-on host machines 540, which in turn be defined by one or more configuration settings within management server 502 (e.g., a configuration value indicating how many users/session a single host machine can support) or determined in a dynamic manner (e.g., based on historical usage data). In some embodiments, power management service 520 may access a lookup table that maps different classes of host machines to capacity values, where host machines may be classified based on their processor type, amount of memory, disk space, etc.

In some embodiments, an organization can enable and configure a balanced auto-scale policy using administrative UI 521. For example, administrative UI 521 may provide controls for enabling a balanced auto-scale policy and setting an organization's preferred value of P. In some embodiments, P may set to a default value for an organization based on one or more factors, such as the type of the organization, the size of the organization (e.g., in terms of number of users), the type of activities the organization participates in, etc. In the case of a DaaS system where the DaaS provider pays for hosting costs, the value of P may be set by the DaaS provider rather than by its customers (i.e., individual organizations).

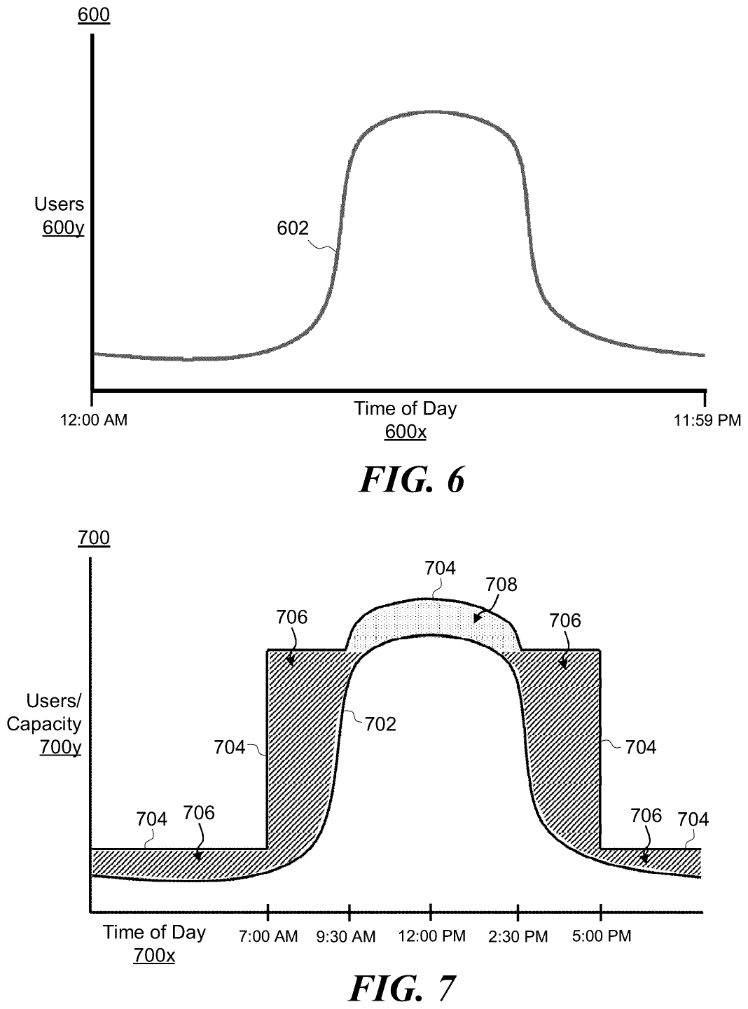

Power management service 520 can include a model generator 530, as shown. For a given organization that is configured to use balanced auto-scaling as disclosed herein, model generator 530 can generate one or more statistical models using historical data tracked by management server 502 and stored in database 514. A description of how the statistical models can be generated and used is provided next, with additional details being provided below in the context of FIGS. 6-9.

First, model generator 530 can receive an organization's historical data tracked over time (e.g., over one or more 24-hour periods) and, from this historical data, it can calculate net logon rate, AU, and machine power-on time, T. Net logon rate, AU, is the first derivative of the user count U (active users) with respect to time. Power-on time refers to the time it takes to power-on a host machine. Power-on time can vary depending on the time-of-day, day-of-week, etc. due to, for example, competition for resources in a shared hosting environment. In some embodiments, net logon rate, AU, can be expressed as users per minute and power-on time, T, can be expressed in minutes. Other units of time may be used. For example, AU and T can be expressed in terms of seconds (more granular) or in terms of hours (less granular). In some embodiments, model generator 530 may receive an organization's historical data from database 514 and, more particularly, from session data 526 and host data 527, which are discussed further below.

Model generator 530 can query session data 526 for sessions that were created or terminated within the given time period and aggregate the results by intervals of time (e.g., by 1, 5, 15, 60, etc. minute intervals) to generate a discrete sequence of values, U, corresponding to user counts during the respective time intervals. This aggregation can include calculating the number of sessions created minus the number of sessions terminated within the respective time interval. For example, the first value of U may correspond to the number of active users during a particular 15-minute interval, the second value of U may correspond to the number of active users within the next 15-minute interval, and so on. In some cases, U can include data for a single day, and the values in U can be associated with a distinct windows of time over the course of a day. For example, a first value of U may correspond to a number of active sessions between 9:00 AM and 9:15 AM, a second value may correspond to a number of active sessions between 9:15 AM and 9:30 AM, etc. In any case, model generator 530 can then calculate the net logon rate, AU, as the first derivative of U. While examples are given herein in terms of 15 minute time intervals, active user counts can be aggregated using other time intervals.

Model generator 530 can access such historical power-on time data from host data 527 to determine an organization's power-on time (T) over a given time period (e.g., over one or more 24 hours periods in the past). In some embodiments, model generator 530 can query for host data 527 for hosts that were powered on within the given time period and aggregate the results by intervals of time (e.g., by 1, 5, 15, 60, etc. minute intervals) to generate a discrete sequence of values, T, corresponding to the average power-on times during the respective time intervals. This aggregation can include, for each powered-on host, calculating the difference between the time the power-on command was issued and the time the host machine completed powering on, and then taking the average of these values. In some cases, T can include data for a single day, and the values in T can be associated with a distinct windows of time over the course of a day. For example, a first value of T may correspond to average power-on time between 9:00 AM and 9:15 AM, a second value may correspond to average power-on time between 9:15 AM and 9:30 AM, etc. While examples are given herein in terms of 15 minute time intervals power-on time can be aggregated using other time intervals.

Model generator 530 can obtain historical data tracked across multiple (N) different days. For example, model generator 530 may obtain separate historical data for each of the previous N days or the previously N weekdays (e.g., N=5, 7, 10, 14, 30, 60, 90, 180, 365, etc.). Model generator 530 can separately aggregate each day's worth of data by interval of time (e.g., 15 minute windows over the course of the day), resulting in N discrete sequences of net logon rates ΔU=ΔU₁, ΔU₂, . . . ΔU_{N} and N discrete sequences of power-on times T=T₁, T₂, . . . , T_{N}.

Next, model generator 530 can receive the configuration value P set for an organization (e.g., from database 514) and calculate the top P percentile of AU and T, resulting in ΔU_{P} and T_{P}, respectively. In more detail, ΔU_{P} can be computed by taking the top P percentile for the same time window over all of the historical data ΔU₁, ΔU₂, . . . ΔU_{N}. For example, if N=30, there would be 30 different values for AU for the 9:00 AM to 9:15 AM time period (assuming the data is aggregated into 15-minute intervals), one value from each of ΔU₁, ΔU₂, . . . ΔU_{N}. In this example, ΔU_{P} can be calculated as the top P percentile of these 30 values, and likewise for all other 15 minute intervals throughout the day. The same approach can be used to calculate T_{P}.

Finally, model generator 530 can generate a model that indicates the different capacities needed to satisfy the organization's preferred value of P at different points in time. In some embodiments, these capacities can be calculated as a product of ΔU_{P} and T_{P}, such as ΔU_{P}*T_{P} or as αΔU_{P}*T, where α and β are weighting constants. Since ΔU_{P} may be negative at certain times (e.g., in the afternoon when users log off), a floor of zero may be set on this calculation, e.g., MAX(ΔU_{P}*T_{P}, 0).

As a simple example, assume that, for a given time-of-day, ΔU_{P} is equal to 5 users/minute and T_{P} is 5 minutes. Then, the organization's target (or “optimal”) capacity at that time-of-day may calculated as 25 users (5 users/min*5 min).

Power management service 520 can use a statistical model generated by model generator 530 to determine the organization's target capacity at a given point in time, and power host machines 504 on/off to achieve the target capacity. For example, power management service 520 may power host machines 504 on/off such that the actual capacity is equal to the target capacity, or substantially equal thereto (e.g., within 1%, 2%, 5%, 10%, etc. of the target capacity). In the case where the model indicates capacity over a 24-hour period, power management service 520 can determine a current time-of-day (e.g., using a system clock) and lookup the target capacity in the model for the current time-of-day (e.g., lookup a discrete value within the sequence generated from the product of ΔU_{P} and T_{P} corresponding to the current time-of-day). The target capacity can be expressed in terms of a number of users/sessions. Power management service 520 may convert between number of users/sessions and number of host machines (e.g., VMs) by dividing the target capacity by the number of users/sessions that each host machine can accommodate (which may be stored as a configuration setting of management server 502, as previously discussed). Power management service 520 can use an organization's statistical model(s) to adjust capacity on a periodic or continuous basis. For example, power management service 520 may adjust capacity every 1 minute, 5 minutes, 10 minutes, 15 minutes, 60 minutes, etc.

In some embodiments, power management service 520 can generate multiple different statistical models for the same organization and can select which of these models to use for auto-scaling based on the current date. For example, power management service 520 may generate/use one model for weekdays (e.g., Monday through Friday) and another model for weekends (e.g., Saturday and Sunday). In some embodiments, management server 502 may allow organizations to configure (e.g., via administrative UI 521) which days of the week correspond to its working days. In this case, power management service 520 may generate/use one model for the configured working days and another model for the remaining days of the week. As another example, power management service 520 may generate/use a different model for each day of the week. As another example, power management service 520 may generate/use a different model for each week of the year or for each month of the year.

In some embodiments, power management service 520 may use a default statistical model for organizations that do not have enough historical data from which to generate a model (e.g., organizations that have less than N days of historical data). The default model may be selected from among a set of default models based on, for example, the type of the organization, the size of the organization (e.g., in terms of number of users), the type of activities the organization participates in, etc.

In some embodiments, power management service 520 may cache generated models within database 514 such that they can be subsequently reused, in order to reduce processing, bandwidth, and other resource usage of the management server 502.

Management server 502 can include, or otherwise have access to, a database 514 configured to store various types of information for delivering virtual applications and desktops and for tracking historical usage. Database 514 may be internal to management server 502 (e.g., an internal hard drive) or external thereto (e.g., an external hard drive, network storage, cloud-based storage, etc.). As illustrated in FIG. 5, database 514 can store configuration data 522, user authentication data 524, session data 526, and host data 527. The data 522, 524, 526, 527 shown in FIG. 5 are not intended to be inclusive of all data that can be stored within or used by a virtual application/desktop management server.

Configuration data 522 can include various settings, policies, and other types of configuration data used by services 516, 518, 520 for providing access to virtual applications and desktops. Notably, configuration data 522 can include auto-scale policies of individual organizations, which policies can be executed by power management service 520. For example, configuration data 522 can include configuration settings corresponding to schedule-policies, load-based policies, and balanced policies as disclosed herein. In the case of a balanced auto-scale policy, configuration data 522 can include the value P set by/for a given organization as well as an indication that balanced auto-scale is enabled for the organization.

Authentication data 524 can include data used by connection brokering service 518 to authenticate end users prior to providing those users with access to virtual applications/desktops on host machines 504. For example, for a given end user, authentication data 524 can include an email address or other user identifier, and a password (or a hashed representation thereof). Various other types of authentication data could be used.

Session data 526 can include data about virtual application/desktop sessions that are actively being hosted on host machines 504 as well as data about historical sessions (e.g., sessions created in the past 24 hours, 7 days, 30 days, 60 days, 1 year, etc.). For a given session, session data 526 can include, for example, data identifying a user of the session, the date/time when the session was created/imitated (e.g., when the user requested access to a virtual application/desktop), the date/time the user logged on to the assigned host machine, the date/time when the session terminated (e.g., when the user logged off of the host machine), data identifying the assigned host machine for the session, data identifying applications running within or otherwise associated with the session, the state of the session (e.g., connected versus disconnected), among other session-related information. As previously discussed, model generator 530 can access historical session data 526 to determine an organization's net logon rate, AU.

Host data 527 can include data about host machines 504 that are available for use in delivering virtual applications and desktops. For example, for a given host machine 504, host data 527 may include network address data (e.g., IP address, port, etc.) that can be used by management server 502 and clients 506 to connect to the host machine via a computer network, data indicating the status of the machine (e.g., powered-on versus powered-off), the date/time the machine was last powered on, data indicating current load on the machine (e.g., as reported by an agent running on the host machine), and historical load on the machine, among other host-related data. Host data 527 can also include, for a given host machine, information about which OS is installed on the host machine, which applications are installed or otherwise available to be run on the host machine, the machine's processor type, memory capacity, disk capacity, and other machine specifications.

Host data 527 can further include historic power-on time data tracked by management server 502. For example, each time a host machine 504 is powered on, management server 502 can store, in host data 527, the time the power-on command was issued to the host machine and the time the host machine completed powering on (i.e., became accessible to end users). This power-on data may be tracked, at least in part, using data reported back from VDAs running on individual host machines 504. For example, a VDA may notify management server 502 when the respective host machine 504 becomes available for end users to log onto, i.e., after it finishes booting, initializing the OS and system services, etc.

As previously mentioned, in some embodiments, model generator 530 can access such historical power-on time data from host data 527 to determine an organization's power-on time (T). In other embodiments, model generator 530 can use session data 526 to determine historical power-on time, T, in place of or in addition to using host data 527. For example, it can infer power-on time based on delta between when a session was initiated and when the user eventually logged on to the host machine for the session.

In some embodiments, particular items of data (e.g., records or objects) stored within database 514 may be linked to or otherwise associated with particular organizations. That is, database 514 may be configured to store data for multiple different organizations.

Although components are shown internal to management server 502, in some embodiments, one or more components may be external to management server 502 (e.g., an external display or input device, external memory devices for data storage, etc.).

Clients 506 can may store and be configured to execute one or more applications for communicating with management server 502 and accessing virtual applications and desktops on host machines 504. For example, a particular client 506 may include an embedded browser or remote desktop application for accessing applications/desktops hosted on host machines 504. Clients 506 can include various types and forms of computing devices executing on behalf of end users, such as desktop computers, laptop computers, tablet computers, smartphones, workstations, etc.

Referring to FIG. 6, plot 600 shows an example of user count at different times of a day, with horizontal axis 600x representing time-of-day and vertical axis 600y representing user count, U. A curve 602 can be generated based on historical session data tracked for an organization, such as data stored within session data 526 of FIG. 5. As illustrated by curve 602, for a given organization, the number of active users may increase in the morning (e.g., between 7 AM and 10 AM), level off mid-day (e.g., between 10 AM and 2 PM), and decrease in the afternoon (e.g., between 2 PM and 5 PM). This may correspond to a typical application/desktop workload for the organization: a higher number of active users during standard working hours (e.g., 7 AM to 5 PM) and a lower number of active users at other times, when capacity can be powered down to save costs. Various types of organizations may exhibit similar patterns.

FIG. 7 shows an example of how existing auto-scale policies may make it difficult to achieve an organization's preferred balance of user experience versus cost savings, leading to a worse user experience and/or higher costs than desired. An illustrative plot 700 includes a horizontal axis 700x representing time-of-day and a vertical axis 700y representing both an organization's user count, U, and its actual capacity (as previously discussed, capacity can be expressed in terms of active users, so a single vertical axis 700y may be used to represent both quantities). A first curve 702 represents user count, U, over time and a second curve 704 represents actual capacity over the same period of time.

As illustrative by curve 704, the organization may use a schedule-based auto-scale policy where capacity is scheduled to increase around 7:00 AM and to decrease around 5:00 PM. As illustrated by curve 702, the organization may experience an increase (or “burst”) of user logons between 7:00 AM and 9:30 AM. This can lead to the user count exceeding or approaching the capacity provided for by the schedule-based policy, starting around 9:30 AM in this example. Assuming the organization also has a load-based policy configured, additional buffer capacity (illustrated by region 708) may be allocated according to the load-based policy starting around 9:30 AM. The load-based buffer capacity may dynamically fluctuate between 9:30 AM and 2:30 PM based on the user count. As seen in FIG. 7, during this period, the shape of capacity curve 704 generally follows that of user count curve 702. Around 2:30 PM, the user count may decrease such that the schedule-based capacity is sufficient to handle the load, meaning that the buffer capacity allocated by load-based policy may be deallocated.

FIG. 7 demonstrates how conventional schedule-based and load-based auto-scale policies may be sub-optimal in terms of user experience and cost savings. In particular, as indicated by regions 706, a schedule-based policy can result in excess capacity at various times of the day, resulting in wasted cost. At the same time, a schedule-based policy may not accommodate bursts of logons (e.g., between approximately 7:30 AM and 9:30 AM in this example), which results in need to allocate additional capacity according to the load-based policy, as indicated by region 708. This may result in users having to wait for additional host machines to power on, resulting in a poor user experience. A balanced auto-scale policy, as disclosed herein, may better accommodate bursts of user logons while, at the same time, achieving an organization's preferred balance of user experience versus cost savings.

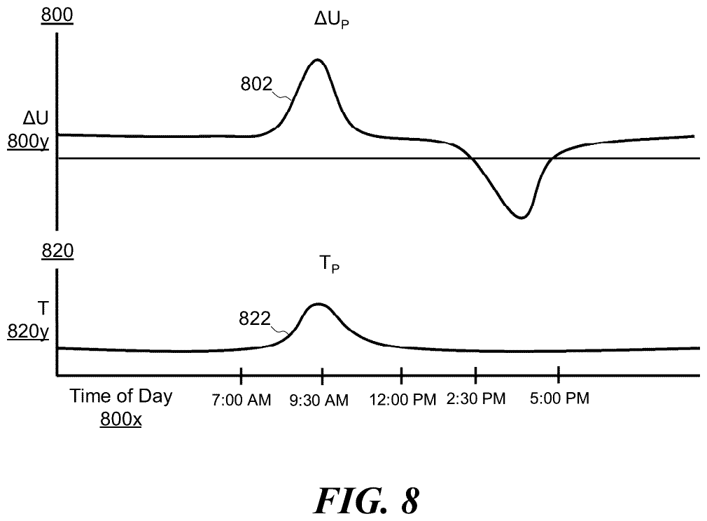

FIG. 8 illustrates historical data that can be tracked and used to generate a statistical model for auto-scaling, according to some embodiments. The data may correspond to data tracked for a single organization and stored, for example, within database 514 of FIG. 5 (or derived from data stored therein). A first plot 800 includes a horizontal axis 800x representing time-of-day, a vertical axis 800y representing net logon rate (e.g., in logons per minute), and a curve 802 representing the top P percentile of net logon rate, ΔU_{P}, over time, where P is a configuration value set for the organization. A second plot 820 shares horizontal axis 800x and includes a vertical axis 820y representing host machine power-on time (e.g., in minutes) along with a curve 822 representing the top P percentile of historical power-on, T_{P}, tracked over time.

The percentile-adjusted net logon rate curve 802, ΔU_{P}, may correspond to the first derivative of the user count curve 702, U, of FIG. 7, adjusted by P. In particular, it can be seen that before 7:00 AM the percentile-adjusted net logon rate curve 802 is relatively flat. Here, even though the net logon rate is essentially zero, curve 802 may greater than zero because the top P percentile of values is taken. Between 7:00 AM and 9:30 AM, curve 802 increases, representing a burst in logons during that period. Starting around 2:30 PM, as the number of active users begins to drop, the percentile-adjusted net logon rate curve 802 can become negative, tracking the downward slope of curve 702 of FIG. 7.

Curve 822 tracks the percentile-adjusted host machine power-on time, T_{P}, over a day. As can be seen, the power-on time remains relatively constant throughout the day but increases between the hours of 7:00 AM and 11:00 AM, approximately. This illustrates that power-on time may be higher during peak periods when, for example, other cloud customers in a region have similar working hours and, thus, there is competition for computing resources.

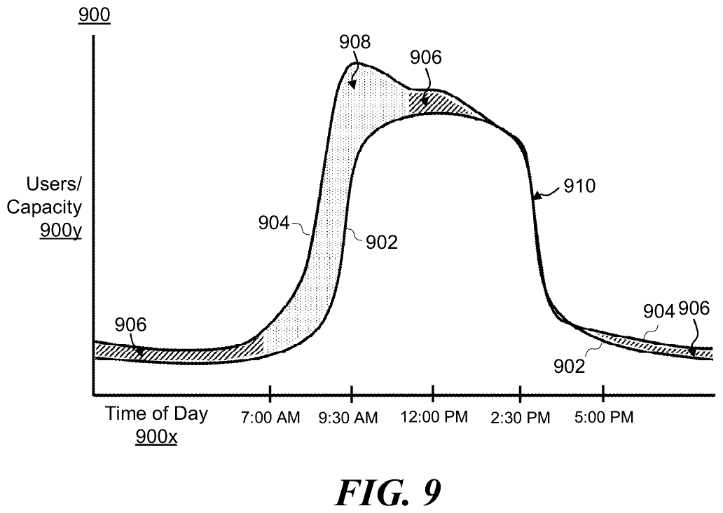

FIG. 9 shows an example of improved auto-scaling that can be achieved using a statistical model, according to some embodiments, resulting in more accurate tuning and cost savings for an organization. An illustrative plot 900 includes a horizontal axis 900x representing time-of-day and a vertical axis 900y representing both user count U and capacity. A first curve 902 represents an organization's user count U over time and a second curve 904 represents its balanced capacity over time. The balanced capacity, represented by curve 904, can be determined using a statistical model generated for an organization. For example, curve 904 may represent ΔU_{P}*T_{P}, as previously defined. During times when curve 904 exceeds curve 902, there is said to be excess of buffer capacity. Of note, before 7:00 AM when there may be historically relatively few logons and/or relatively fast power-on times, buffer capacity is relatively low as indicated by region 906. Between approximately 7:00 AM and 10:30 AM when there may be historically more logons and/or increased power-on times, buffer capacity increases as indicated by region 908 by dint of the generated statistical model (e.g., the product of ΔU_{P} and T_{P}). Starting around 2:00 PM, when historical net logon rate (AU) is negative (i.e., more users log off than on) and/or historical power-on times are low, there may be zero, or substantially zero, buffer capacity as indicated by region 910.

As illustrated by FIG. 9, the balanced auto-scale policy disclosed herein can be used to provide optimal, or near optimal, buffer capacity throughout an organization's working day and achieve the organization's preferred balance of user experience and cost saves according to a single configuration value, P.

FIG. 10 shows an example of UI for configuring auto-scaling, according to some embodiments. Illustrative UI 1000 may be implemented, for example, within administrative UI 521 of FIG. 5. The UI 1000 includes a navigation pane 1004 with selectable menu items 1004a-1004e for accessing different collections of auto-scale settings. In the example show, UI 1000 can include general auto-scale settings 1004a, load-based policy settings 1004b, schedule-based policy settings 1004c, balanced policy settings 1004d, and advanced auto-scale settings 1004e.

UI 1000 further includes a content pane 1006 that is configured to dynamically update depending on which of the menu items 1004a-1004e is selected. In the example of FIG. 10, balanced policy settings 1004d are selected and, thus, content pane 1006 is shown as having UI controls related to a balanced policy, as disclosed herein. In particular, content pane 1006 includes a checkbox 1008 to enable/disable the balanced auto-scale policy for an organization, and a slider control 1010 for setting the organization's preferred balance of cost savings versus user experience. The position of the slider 1010 can be adjusted to change the value P for the organization. For example, if slider 1010 is positioned to the far left (“Minimum Cost”), the value of P can be set to 0%. As another example, if slider 1010 is positioned to the far right (“Maximum Availability”), the value of P can be set to 100%. In some embodiments, the organization's balanced auto-scale statistical model can be generated/updated in response to a change in the state of checkbox 1008 and/or to a change in the position of slider 1010.

In some embodiments, an administrative UI can display historical usage and/or power-on times tracked for an organization. In some embodiments, an administrative UI can show the performance of recent user logons (e.g., how many logons had to wait for a host machine to power on and how many did not) and a comparison of this actual performance versus the organization's preferred performance target, as specified by the configuration value P.

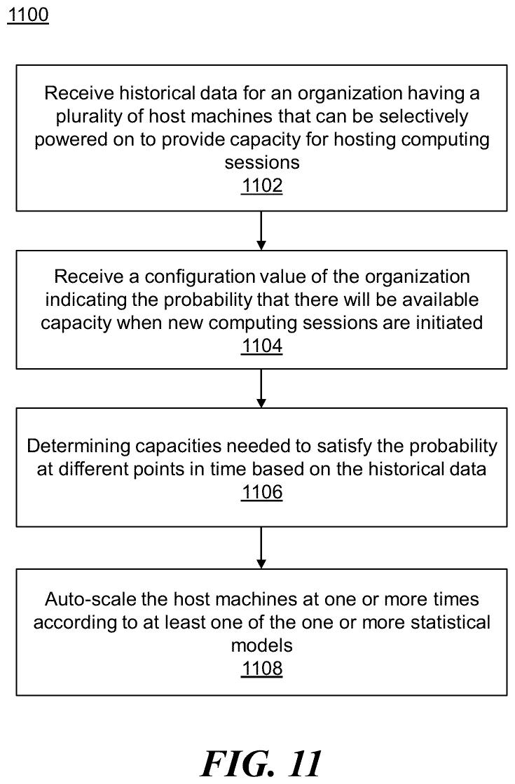

FIG. 11 illustrates a method 1100 for auto-scaling using statistical models, according to some embodiments. In some embodiments, method 1100 can be implemented within and executed by management server 502 of FIG. 5.

At block 1102, historical data can be received for an organization having a plurality of host machines that can be selectively powered on to provide capacity for hosting computing sessions (e.g., virtual desktop/application sessions). In some embodiments, this can include receiving data about numbers of logons that occurred at the different points in time and receiving data about amounts of time required to power on one or more of the host machines at the different points in time. In some embodiments, the different points in time include times of day. In some embodiments, the receiving of the historical data includes receiving historical data associated with one or more 24-hour periods. Any of the techniques previously described for tracking, storing, querying, and/or aggregating historical data for an organization can be employed within block 1102.

At block 1104, a configuration value of the organization can be received, the configuration value indicating the probability that there will be available capacity when new computing sessions are initiated. Any of the techniques previously described for setting and retrieving this configuration value for an organization can be employed within block 1104.

At block 1106, capacities needed to satisfy the configured probability (from block 1104) at different points in time can be determined based on the historical data (from block 1102). In some embodiments, this can include generating one or more statistical models can be generated for the organization using the received historical data and the configuration value, each of the one or more statistical models indicating different capacities needed to satisfy the probability at different points in time. In some embodiments, the generating of the one or more statistical models can include generating a plurality of statistical models for the organization, where different ones of the plurality correspond to different days of the weeks. In such embodiments, the auto-scaling of the host machines according to at the least one of the one or more statistical models can include: determining a current day-of-week and selecting the at least one of the statistical models from the plurality based on the current day-of-week. Any of the techniques previously described for generating statistical models for an organization can be employed within block 1106.

At block 1108, the host machines can be auto-scaled at one or more times according to at least one of the one or more statistical models. In some embodiments, this can include: determining a current time-of-day; determining, from the at least one of the one or more statistical models, a target capacity needed to satisfy the probability at the current time-of-day; and powering on at least one of the plurality of host machines to achieve the target capacity. In some embodiments, block 1108 can include periodically auto-scaling the host machines at one or more times according to the at least one of the one or more statistical models. Any of the techniques previously described for auto-scaling using a statistical model can be employed within block 1108.

The auto-scale techniques and structures disclosed herein may be applied to various types of hosting systems and are not limited to VDI/DaaS systems. The statistical model approach to auto-scale disclosed herein may be combined with other modeling techniques, including various machine learning (ML) techniques to further improve auto-scaling efficiency, cost savings, and/or user experience for organizations of various types and sizes.

The following examples pertain to further embodiments, from which numerous permutations and configurations will be apparent.

Example 1 includes a method including: receiving, by a computing device, historical data for an organization having a plurality of host machines that can be selectively powered on to provide capacity for hosting computing sessions; receiving, by a computing device, a configuration value of the organization indicating a probability that there will be available capacity when new computing sessions are initiated; determining, by the computing device, capacities needed to satisfy the probability at different points in time based on the historical data; and auto-scaling the host machines at one or more times according to the determined capacities.

Example 2 includes the subject matter of Example 1, wherein the receiving of the historical data includes: receiving data about numbers of logons that occurred at the different points in time; and receiving data about amounts of time required to power on one or more of the host machines at the different points in time.

Example 3 includes the subject matter of Example 1 or 2, wherein the different points in time include times of day.

Example 4 includes the subject matter of Example 3, wherein the receiving of the historical data includes receiving historical data associated with multiple 24-hour periods.

Example 5 includes the subject matter of any of Examples 1 through 4, wherein the auto-scaling of the host machines at the one or more times includes: determining a current time-of-day; determining, from the at determined capacities, a target capacity needed to satisfy the probability at the current time-of-day; and powering on at least one of the plurality of host machines to achieve the target capacity.

Example 6 includes the subject matter of any of Examples 1 through 5, wherein the computing sessions include virtual desktop sessions.

Example 7 includes the subject matter of any of Examples 1 through 6, wherein the auto-scaling of the host machines at the one or more times includes: periodically auto-scaling the host machines at one or more times according to the determined capacities.

Example 8 includes the subject matter of any of Examples 1 through 7, wherein the determining of the capacities needed to satisfy the probability at the different points in time includes: determining a current day-of-week, selecting, from the historical data, data associated with the current day-of-week, and determining the capacities needed to satisfy the probability at the different points in time based on the selected data.

Example 9 includes an apparatus including: a processor; and a memory storing computer program code that when executed on the processor causes the processor to execute a process including: receiving historical data for an organization having a plurality of host machines that can be selectively powered on to provide capacity for hosting computing sessions; receiving a configuration value of the organization indicating a probability that there will be available capacity when new computing sessions are initiated; determining capacities needed to satisfy the probability at different points in time based on the historical data; and auto-scaling the host machines at one or more times according to the determined capacities.

Example 10 includes the subject matter of Example 9, wherein the receiving of the historical data includes: receiving data about numbers of logons that occurred at the different points in time; and receiving data about amounts of time required to power on one or more of the host machines at the different points in time.

Example 11 includes the subject matter of Example 9 or 10, wherein the different points in time include times of day.

Example 12 includes the subject matter of Example 11, wherein the receiving of the historical data includes receiving historical data associated with multiple 24-hour periods.

Example 13 includes the subject matter of any of Examples 9 to 12, wherein the auto-scaling of the host machines at the one or more times includes: determining a current time-of-day; determining, from the at determined capacities, a target capacity needed to satisfy the probability at the current time-of-day; and powering on at least one of the plurality of host machines to achieve the target capacity.

Example 14 includes the subject matter of any of Examples 9 to 13, wherein the computing sessions include virtual desktop sessions.

Example 15 includes the subject matter of any of Examples 9 to 14, wherein the auto-scaling of the host machines at the one or more times includes: periodically auto-scaling the host machines at one or more times according to the determined capacities.

Example 16 includes the subject matter of any of Examples 9 to 15, wherein the determining of the capacities needed to satisfy the probability at the different points in time includes: determining a current day-of-week, selecting, from the historical data, data associated with the current day-of-week, and determining the capacities needed to satisfy the probability at the different points in time based on the selected data.

Example 17 includes a non-transitory machine-readable medium encoding instructions that when executed by one or more processors cause a process to be carried. The process includes: receiving, by a computing device, historical data for an organization having a plurality of host machines that can be selectively powered on to provide capacity for hosting computing sessions; receiving, by a computing device, a configuration value of the organization indicating a probability that there will be available capacity when new computing sessions are initiated; determining, by the computing device, capacities needed to satisfy the probability at different points in time based on the historical data; and auto-scaling the host machines at one or more times according to the determined capacities.

Example 18 includes the subject matter of Example 17, wherein the receiving of the historical data includes: receiving data about numbers of logons that occurred at the different points in time; and receiving data about amounts of time required to power on one or more of the host machines at the different points in time.

Example 19 includes the subject matter of any of Example 17 or 18, wherein the auto-scaling of the host machines at the one or more times includes: determining a current time-of-day; determining, from the at determined capacities, a target capacity needed to satisfy the probability at the current time-of-day; and powering on at least one of the plurality of host machines to achieve the target capacity.

Example 20 includes the subject matter of any of Examples 17 to 19, wherein the determining of the capacities needed to satisfy the probability at the different points in time includes: determining a current day-of-week, selecting, from the historical data, data associated with the current day-of-week, and determining the capacities needed to satisfy the probability at the different points in time based on the selected data.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, by a computing device, historical data for an organization having a plurality of host machines that can be selectively powered on to provide capacity for hosting computing sessions;
receiving, by a computing device, a configuration value of the organization indicating a probability that there will be available capacity when new computing sessions are initiated;
determining, by the computing device, capacities needed to satisfy the probability at different points in time based on the historical data; and
auto-scaling the host machines at one or more times according to the determined capacities.

2. The method of claim 1, wherein the receiving of the historical data includes:
receiving data about numbers of logons that occurred at the different points in time; and
receiving data about amounts of time required to power on one or more of the host machines at the different points in time.

3. The method of claim 2, wherein the different points in time include times of day.

4. The method of claim 3, wherein the receiving of the historical data includes receiving historical data associated with multiple 24-hour periods.

5. The method of claim 1, wherein the auto-scaling of the host machines at the one or more times includes:
determining a current time-of-day;
determining, from the at determined capacities, a target capacity needed to satisfy the probability at the current time-of-day; and
powering on at least one of the plurality of host machines to achieve the target capacity.

6. The method of claim 1, wherein the computing sessions include virtual desktop sessions.

7. The method of claim 1, wherein the auto-scaling of the host machines at the one or more times includes:
periodically auto-scaling the host machines at one or more times according to the determined capacities.

8. The method of claim 1, wherein the determining of the capacities needed to satisfy the probability at the different points in time includes:
determining a current day-of-week,
selecting, from the historical data, data associated with the current day-of-week, and
determining the capacities needed to satisfy the probability at the different points in time based on the selected data.

9. An apparatus comprising:
a processor; and
a memory storing computer program code that when executed on the processor causes the processor to execute a process including:
receiving historical data for an organization having a plurality of host machines that can be selectively powered on to provide capacity for hosting computing sessions;
receiving a configuration value of the organization indicating a probability that there will be available capacity when new computing sessions are initiated;
determining capacities needed to satisfy the probability at different points in time based on the historical data; and
auto-scaling the host machines at one or more times according to the determined capacities.

10. The apparatus of claim 9, wherein the receiving of the historical data includes:
receiving data about numbers of logons that occurred at the different points in time; and
receiving data about amounts of time required to power on one or more of the host machines at the different points in time.

11. The apparatus of claim 9, wherein the different points in time include times of day.

12. The apparatus of claim 11, wherein the receiving of the historical data includes receiving historical data associated with multiple 24-hour periods.

13. The apparatus of claim 9, wherein the auto-scaling of the host machines at the one or more times includes:
determining a current time-of-day;
determining, from the at determined capacities, a target capacity needed to satisfy the probability at the current time-of-day; and
powering on at least one of the plurality of host machines to achieve the target capacity.

14. The apparatus of claim 9, wherein the computing sessions include virtual desktop sessions.

15. The apparatus of claim 9, wherein the auto-scaling of the host machines at the one or more times includes:
periodically auto-scaling the host machines at one or more times according to the determined capacities.

16. The apparatus of claim 9, wherein the determining of the capacities needed to satisfy the probability at the different points in time includes:
determining a current day-of-week,
selecting, from the historical data, data associated with the current day-of-week, and
determining the capacities needed to satisfy the probability at the different points in time based on the selected data.

17. A non-transitory machine-readable medium encoding instructions that when executed by one or more processors cause a process to be carried, the process including:
receiving, by a computing device, historical data for an organization having a plurality of host machines that can be selectively powered on to provide capacity for hosting computing sessions;
receiving, by a computing device, a configuration value of the organization indicating a probability that there will be available capacity when new computing sessions are initiated;
determining, by the computing device, capacities needed to satisfy the probability at different points in time based on the historical data; and
auto-scaling the host machines at one or more times according to the determined capacities.

18. The non-transitory machine-readable medium of claim 17, wherein the receiving of the historical data includes:
receiving data about numbers of logons that occurred at the different points in time; and
receiving data about amounts of time required to power on one or more of the host machines at the different points in time.

19. The non-transitory machine-readable medium of claim 17, wherein the auto-scaling of the host machines at the one or more times includes:
determining a current time-of-day;
determining, from the at determined capacities, a target capacity needed to satisfy the probability at the current time-of-day; and
powering on at least one of the plurality of host machines to achieve the target capacity.

20. The non-transitory machine-readable medium of claim 17, wherein the determining of the capacities needed to satisfy the probability at the different points in time includes:
determining a current day-of-week,
selecting, from the historical data, data associated with the current day-of-week, and
determining the capacities needed to satisfy the probability at the different points in time based on the selected data.
